(19) United States
(12) Patent Application Publication
(10) Pub. No.: US 2025/0277381 A1
(43) Pub. Date: Sep. 4, 2025

(54) DEVICE FOR STRUCTURAL REINFORCEMENT FOR 3D PRINTING IN GEOTECHNICAL ENGINEERING AND EARTH BUILDINGS SUCH AS MUD BUILDINGS

(71) Applicants: Hamed NIROUMAND, Tehran (IR); Lech Balachowski, Gdansk (PL)

(72) Inventors: Hamed NIROUMAND, Tehran (IR); Lech Balachowski, Gdansk (PL)

(21) Appl. No.: 18/593,972

(22) Filed: Mar. 3, 2024

(51) Int. Cl. E04G 21/12; B28B 1/00; B33Y 30/00

(52) U.S. Cl. CPC E04G 21/12; B28B 1/001; B33Y 30/00

(57) ABSTRACT

A device for structural reinforcement for 3D printing in geotechnical engineering, comprising a driving system (50) for positioning of the production unit (7) in a three dimensional space (x, y, z) on a construction site (1), wherein the production unit (7) comprises a first production assembly (20) and a second production assembly (30), wherein the first production assembly (20) and the second production assembly (30) are designed to operate with different construction materials. At least one of said construction materials is a reinforcement construction material for reinforcing the geotechnical structure to be created during operation of the device, such that the geotechnical structure after being cured resists a shear forces or horizontal forces higher than the same geotechnical structure build without the reinforcement material.

### BACKGROUND OF THE INVENTION

### Field of the Invention

The present disclosure generally relates to material engineering, and more particularly to a device for erecting structures like walls, foundations, buildings and the like, and their structural reinforcement for 3D printing in geotechnical engineering, earthen buildings and mud technologies on the Earth and Space such as the Moon, Mars and others, such as digital fabrication and automation system in Space Reinforcement system.

### Brief Description of the Background of the Invention Including Prior Art

With a significant development in 3D printing field in recent years, many new applications emerge for this versatile technology. One such use is geotechnical construction engineering. A relatively simple 3D printer design can be used to quickly construct simple, durable buildings using materials available at the construction site. The process of 3D-printing a building generally involves pouring the construction material in layers forming a series of walls. One of the most important factors of a 3D printed building is its strength characteristics—how the walls perform under various conditions and loads subjected by the building in the environment. A standard 3D-printed wall consists of a number of printing material layers stacked one on top of the other. Such a design is characterized by a limited shear resistance, dependent on the printing material used, which in turn is limited by the design of the 3D printer itself—the better the bonding of the printing material the harder it is to pump and dispense it using a 3D printer device. One solution of this problem is to provide additional structural reinforcement of the 3D printed wall.

As explained in “State of the Art Review of Reinforcement Strategies and Technologies for 3D Printing of Concrete” (Al-Rubaye et al, 2022), such reinforcement can be achieved for example by means of steel or FRP (Fiber-reinforced polymers) rebars or by fiber reinforcement, added during the mixing or printing process. In order to optimize the construction time and minimize the required human labor, an automated 3D printing device is needed which can also automatically apply additional reinforcement to the 3D printed wall.

Document WO2023031302A1 discloses a mobile 3D printer device which can print structures or other objects flexibly and continuously. The invention also relates to a mobile 3D printer comprising at least one vehicle trailer having a rail system, and further comprising at least one carriage which is movable on the rail system and has a vertically movable crane robot, the crane robot being rotatable or pivotable and there being a telescopic arm or a cantilever arranged on the crane robot, at least receiving means for a printing device and/or reinforcement device being provided on the telescopic arm and/or the cantilever.

Document JP2015217682A discloses a 3D printing device and method, and construction method of reinforced concrete structure utilizing the device. The invention provides a 3D printing device and a method for producing a three-dimensional solid object by utilizing a concrete mixture as a print raw material, and to provide a construction method of a reinforced concrete structure utilizing the device. A 3D printing device includes a base frame, a moving part provided movably on an upper part of the base frame, and an extrusion head provided on one side of the moving part, for discharging a concrete mixture which is a print raw material onto the surface side of the base frame.

Document US2023339140A1 discloses a 3D printer for construction for print-molding various structures, in which a main pipe for transferring a filament material therein is installed inside a nozzle for discharging a printing material, such as concrete or mortar, to enable co-printing of the filament material with the printing material while embedded in the printing material. According to the disclosure, in constructing a structure by a 3D printer for construction, a printing material embedded with the filament material as reinforcing material may be printed, and as a result, the effects of reinforcing tensile strength of the printed object and inhibiting crack of the printed object may be obtained.

### Technical Problem

Prior art solutions solve some of the problems involved in the 3D printing and reinforcing process but the resulting shear resistance of the walls constructed using these methods and appliances is limited and the resulting design of the devices is often overly complicated, thus a more refined and simple solution is needed.

### SUMMARY OF THE INVENTION

### Purposes of the Invention

It is an object of the present invention to provide a device for structural reinforcement for 3D printing in geotechnical engineering and earthen buildings on the Earth and Space such as the Moon, Mars and other extraterrestrial bodies which are possible to visit by humans, which overcomes the drawbacks of the prior art.

### BRIEF DESCRIPTION OF THE INVENTION

The present invention relates to a device for structural reinforcement for 3D printing in geotechnical engineering on the Earth and Space Geotechnics on the Space such as the Moon, Mars and other extraterrestrial bodies which are possible to visit by humans, which comprises a first horizontal rail, a second horizontal rail, a first vertical rail, a second vertical rail, a third horizontal rail, a production unit a supply system for the clay and a control system. The first horizontal rail, the second horizontal rail, the first vertical rail, the second vertical rail, and the third vertical rail create a driving system for positioning of the production unit in a three dimensional space on a construction site. The driving system is also called a cartesian robot or a linear robot, which is an industrial robot whose three principal axes of control are linear i.e. they move in a straight line rather than rotating, and are at right angles to each other. The invention is characterized in that the production unit comprises a first production assembly, also called a clay or concrete 3D printer, and a second production assembly, also called a metal 3D printer, wherein the first production assembly and the second production assembly are designed to operate with different construction materials, wherein at least one of said construction materials is a reinforcement construction material for reinforcing the geotechnical structure to be created during operation of the device, such that the geotechnical structure after being cured resists a shear forces or horizontal forces higher than the same geotechnical structure build without the reinforcement material.

Preferably, the driving system comprises a first drive unit, a second drive unit, a third drive unit, a fourth drive unit and a fifth drive unit, wherein said drive units are connected by electrical wires or wirelessly to a control system comprising an input unit, a processor, a non-volatile memory and an output unit. The drive units can be in a form of any known drives, like for example a linear module with toothed rack. In this case an electric motor driving a gear is connected to one part and a toothed rack is connected to the other part. By actuating the electric motor the gear turns and while engaged with the toothed rack causes the movement of the toothed rack attached to the respective part in the desired direction and desired distance. The first drive unit and the second drive unit when actuated work simultaneously to move the first vertical rail and the second vertical rail simultaneously along the first horizontal rail and the second horizontal rail. The third drive unit and the fourth drive unit when actuated work together to move both ends of the third horizontal rail along the first vertical rail and the second vertical rail respectively, so the third horizontal rail is movable substantially horizontal. The fifth drive unit when actuated moves the production unit along the third horizontal rail between the first and second ends of the horizontal rail. The processor when executing a computer program according to an input data or a design program stored in the memory is operable to send signals to the executive unit to actuate the production unit and to turn on and off said first, second, third and fourth drives respectively to move the production unit within the space defined by the Cartesian coordinate driving system in order to create the geotechnical structure according to the design. Such linear robots are well known so there is no need to describe its construction, operation or control in more details.

Preferably, this device includes at least two printing nozzles, more specific, the first production assembly comprises a first printing nozzle, also called a first clay or concrete feeder, and a second printing nozzle, also called a second clay or concrete feeder. Said nozzles are designed for 3D printing with a first material such as clay, concrete, mud or earth materials. The second construction assembly comprises a third printing nozzle, also called a wire or powder feeder, for 3D printing with a second material such as polymer, steel or related materials as reinforcement materials. The second construction assembly also comprises a forth printing nozzle, also called a laser nozzle.

Preferably, the first material is a construction material selected from a group consisting of: clay, silt, mud, regolith, Mars soil, simulants, space soils. As the first material any material suitable for construction are usable, either Earth-based or Extraterrestrial. For example, when the construction takes place on Earth, materials such as clay, silt, mud etc are usable as the first material. Otherwise, when the construction takes place in Space, it means on extraterrestrial bodies such as on Moon, on Mars etc., materials such as regolith, Mars soil, and various types of simulants and space soils are usable as the first material.

Preferably, the second material is a reinforcement construction material selected from a group consisting of: polymer, steel, fibers, composites, wood and others.

Preferably, the reinforcement construction material comprises one or more materials selected from a group consisting of: rebar, geosynthetics, fibers. The reinforcement construction material can comprise any types of reinforcement materials known in the art and suitable for providing a required reinforcement.

Preferably, the second production unit comprises a roll drive for holding and unwinding a geosynthetics roll, a rebar magazine for rebars and a vertical cutter.

### BRIEF DESCRIPTION OF THE DRAWINGS

These aims together with other objects and advantages which will become subsequently apparent reside in the details of the construction and operation as more fully hereinafter described and claimed, reference being made to the accompanying drawings forming a part hereof, wherein the same numerals refer to the same parts throughout.

In drawings

FIG. 1 illustrates a perspective view of the device for structural reinforcement for 3D printing, including the a driving system 50, installed on a construction site,

FIG. 2 illustrates a perspective view of a production unit 7, comprising a 1st production assembly 20 and a 2nd production assembly 30,

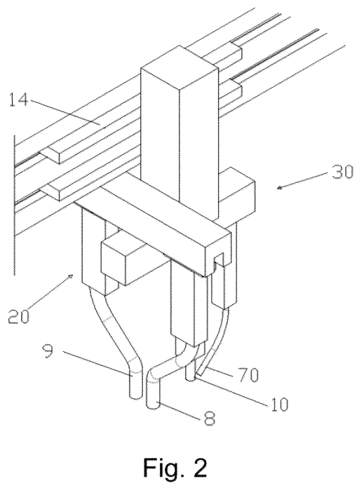

FIG. 3 illustrates schematically a perspective view of the production unit 7 comprising a second production assembly 30 equipped with a geosynthetics roll 10,

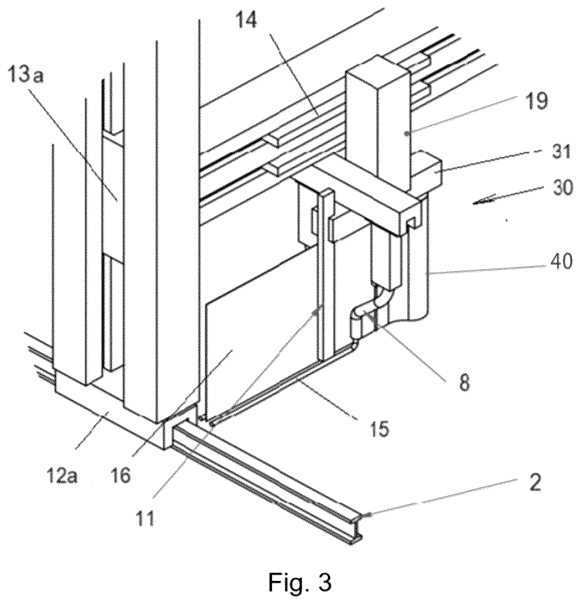

FIG. 4 illustrates schematically a side view of the production unit 7 shown on FIG. 3.

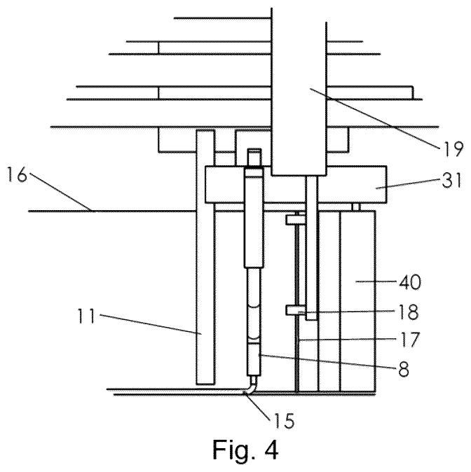

### DETAILED DESCRIPTION OF INVENTION AND PREFERRED EMBODIMENT

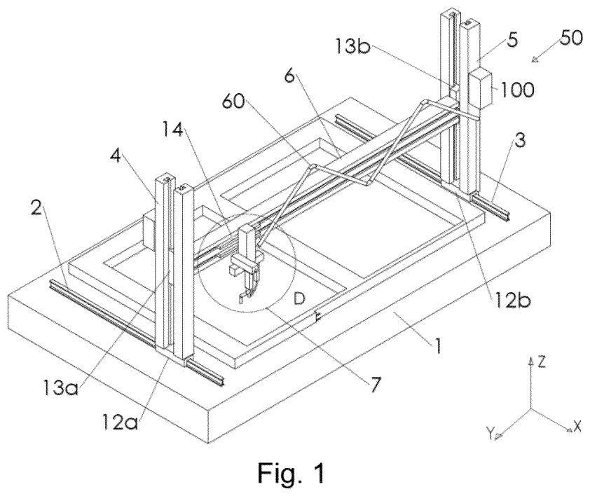

Referring to the drawing, FIG. 1 shows schematically a device for structural reinforcement for 3D printing in geotechnical engineering, comprising a first horizontal rail 2, a second horizontal rail 3, a first vertical rail 4, a second vertical rail 5, a third horizontal rail 6, a production unit 7, a supply system 60 for the clay and a control system 100. The first horizontal rail 2, the second horizontal rail 3, the first vertical rail 4, the second vertical rail 5, and the third vertical rail 6 create a driving system 50 for positioning of the production unit 7 in a three dimensional space x, y, z on a construction site 1. The production unit 7 comprises a first production assembly 20 and a second production assembly 30, both also called a clay or concrete feeder. The first production assembly 20 is designed to operate with a standard production material as clay, silt or mud, and the second production assembly 30 is designed to operate with a reinforcement construction material such as profiled or rounded polymer or steel bars, profiled fibers structures, profiled composite structures and wooden beams for reinforcing the geotechnical structure to be created during operation of the device, such that the geotechnical structure after being cured resists a shear forces or horizontal forces higher than the same geotechnical structure build without the reinforcement material.

The driving system 50 is a driving system which provides movement of the production unit 7 in a three dimensional space or within a Cartesian coordinate system specified by the coordinates x, y, z, which indicate the length, the width and the height of the total space or cuboid which will contain the whole build structure after completed. It means the production unit 7 when operated is driven along a predetermined paths in the space determined by coordinates x, y and z as measured from a center of the coordinate system, which can be placed anywhere within the space specified by the coordinates x, y, z. For example, for building a wall the production unit 7 is driven along a predetermined line with a predetermined speed, e.g. along a line perpendicular to axis y, with a speed from 1 to 5 mm/sec, and simultaneously during this movement the first production assembly 20 and the second production assembly 30 apply the respective materials on the construction site along the predetermined production line. The production lines of the materials on one layer join together and create a continuous construction line according to the chosen design. The materials are then cured for the predetermined time, for example 300 seconds, and the production process is repeated for the next layers put on top of the previous layers until the predetermined or designed height of the wall is reached. The driving system 50 comprises a first drive unit 12a, a second drive unit 12b, a third drive unit 13a, a fourth drive unit 13b and a fifth drive unit 14. The drive units are standard drive units. Said drive units are connected by electrical wires to a control system 100, which in this case is a personal computer comprising an input unit, a processor, a non-volatile memory and an output unit. The processor when executing a computer program according to input data or a design program stored in the memory sends signals to the executive unit to actuate the production unit 7 and to turn on and off said drives respectively to move the production unit 7 within the space x, y, z and time t in order to create the geotechnical structure according to the design. The first production assembly 20 comprises a first printing nozzle 8 and a second printing nozzle 9, said nozzles being designed for 3D printing with a first material 15, which is a construction material selected from a group consisting of: earth materials such as various types of clay, silt, mud and others. In Space, regolith, Mars soil, and various types of simulants and space soils are usable instead.

The second construction assembly 30 comprises a third printing nozzle 10 for 3D printing with a second material 16, which is a reinforcement construction material selected from a group consisting of: polymer bars, steel bars, fiber structures, composite structures, and others.

In one embodiment the clay is applied on the construction site by a first printing nozzle 8 and a second printing nozzle 9, wherein in between of the applied clay is introduced the reinforcement material which in this case is a polymer. The production of the structure in this case is as follows soil reinforcement techniques for Earth and Space such as the Moon, Mars and etc.

In other embodiment the reinforcement construction material comprises a rebar and geosynthetics. The geosynthetics is chosen according to the specific construction site and in different embodiments can comprise: geotextiles, geogrids, geonets, geomembranes, geosynthetic clay liners, geofoam, geocells, geojackets and geocomposites. The second production unit 30 in this embodiment comprises a roll drive 31 for holding and unwinding a geosynthetics roll 10, a rebar magazine 19 for rebars 17 and a vertical cutter 11. The production of the structure in this case is as follows soil and mud reinforcement techniques.

### Technical Applicability

The device according the invention can be used for erecting structures like walls, foundations, buildings and the like, and for their structural reinforcement for 3D printing in geotechnical engineering.

### REFERENCE LIST

1-Base, construction site
2-First horizontal rail
3-Second horizontal rail
4-First vertical rail
5-Second vertical rail
6-Third horizontal rail
7-Production unit
8-First printing nozzle, clay or
concrete feeder
9-Second printing nozzle, clay or
concrete feeder
10-Third printing nozzle, wire or
powder feeder
11-Roll cutter
12a-First drive unit
12b-Second drive unit
13a-Third drive unit
13b-Fourth drive unit
14-Fifth drive unit
15-First material
16-Second material
17-Rebar
18-Rebar tying tools
19-Rebar magazine
20-1st production assembly, clay or
concrete 3D printer
30-2nd production assembly, metal
3D printer
40-Geosynthetics roll
50-Driving system
60-Supply system for the clay
70-Fourth printing nozzle, laser nozzle
100-Control system

What is claimed is:

1. A device for structural reinforcement for 3D printing in geotechnical engineering, comprising a first horizontal rail (2), a second horizontal rail (3), a first vertical rail (4), a second vertical rail (5), a third horizontal rail (6), a production unit (7) and a control system (100), wherein the first horizontal rail (2), the second horizontal rail (3), the first vertical rail (4), the second vertical rail (5), and the third vertical rail (6) create a driving system (50) for positioning of the production unit (7) in a three dimensional space (x, y, z) on a construction site (1), wherein the production unit (7) comprises a first production assembly (20) and a second production assembly (30), wherein the first production assembly (20) and the second production assembly (30) are designed to operate with different construction materials, wherein at least one of said construction materials is a reinforcement construction material for reinforcing the geotechnical structure to be created during operation of the device, such that the geotechnical structure after being cured resists a shear forces or horizontal forces higher than the same geotechnical structure build without the reinforcement material.

2. The device according to claim 1, wherein the driving system (50) comprises a first drive unit (12a), a second drive unit (12b), a third drive unit (13a), a fourth drive unit (13b) and a fifth drive unit (14), wherein said drive units are connected by electrical wires or wirelessly to a control system (100) comprising an input unit, a processor, a memory and an output unit, wherein the processor when executing a computer program according to input data or a design program stored in the memory is operable to send signals to the executive unit to actuate the production unit (7) and to turn on and off said drives respectively to move the production unit (7) within the space (x, y, z) and time (t) in order to create the geotechnical structure according to the design.

3. The device according to claim 1, wherein the first production assembly (20) comprises a first printing nozzle (8) and a second printing nozzle (9), said nozzles designed for 3D printing with a first material (15), and wherein the second construction assembly (30) comprises a third printing nozzle (10) for 3D printing with a second material (16).

4. The device according to claim 3, wherein the first material (15) is a construction material selected from a group consisting of: clay, silt, mud, regolith, Mars soil, simulants, space soils.

5. The device according to claim 3, wherein the second material (16) is a reinforcement construction material selected from a group consisting of: polymer, steel, fibers, composites, wood.

6. The device according to claim 1, wherein the reinforcement construction material comprises one or more materials selected from a group consisting of: rebar, geosynthetics, fibers.

7. The device according to claim 1, wherein the second production unit (30) comprises a roll drive (31) for holding and unwinding a geosynthetics roll (10), a rebar magazine (19) for rebars (17) and a vertical cutter (11).
